(19) United States
(12) Patent Application Publication
(10) Pub. No.: US 2011/0064616 A1
(43) Pub. Date: Mar. 17, 2011

(54) TRANSPORT DETECTOR FOR LIQUID CHROMATOGRAPHY

(76) Inventor: Yury Zelechonok, Northbrook, IL (US)

(21) Appl. No.: 12/704,500

(22) Filed: Feb. 11, 2010

Related U.S. Application Data
(60) Provisional application No. 61/276,799, filed on Sep. 17, 2009.

(51) Int. Cl. G01N 30/02; B01D 15/08

(52) U.S. Cl. 422/70

(57) ABSTRACT

A transport detector for Liquid Chromatography includes a spinning disk covered in a non-wettable, non-transparent material with a wettable transparent channel left for a mobile phase. A mobile phase is delivered from a chromatography column into the channel. A light source with focusing optics is set along the channel path and array of sensors for optical signal detection are mounted along the path of the light. The disk rotation could be set at different speeds by a motor, allowing the operator to control the thickness of the liquid layer in the channel. Varying the thickness of liquid changes the length of the optical cell of the detector, which allows adjusting the sensitivity of the detector. The spinning disk design allows for using of multiple sensors of different kind as well as different detection methods. Also, the array of sensors of the same kind could be used to perform multiple measures of the same portion of the mobile phase. This feature improves the Signal to Noise ratio of the detector. The detector has a wiping and vacuuming device at the end of the channel's circular path to regenerate the channel for the new mobile phase entry.

### CROSS-REFERENCE TO RELATED APPLICATION

This application is based on and claims benefit to U.S. provisional applications 61/276,799 filed on Sep. 17, 2009.

### BACKGROUND OF THE INVENTION

The present invention relates to liquid chromatography (LC), and more particularly to LC detectors. Generally in LC, the mobile phase after exiting the column is passing through a detector. LC detector is a device that senses changes in the mobile phase physical properties due to the presence of the analyzed mixture components (analytes). For instance, the output of the LC detector could be a function of quantity of analyte passing through it per either unit of time or per unit of volume of mobile phase.

Among others, LC could utilize flame-ionization, electrical conductivity or optical detectors. Flame-ionization detector (FID) is the most sensitive and is mainly used for hydrocarbons determination. FID found a very limited application in LC due to its decreased response to heteroatoms like oxygen, nitrogen and sulfur. The majority of the liquid eluents used in LC contain carbon atoms which creates a large “background” noise if passed directly into an FID. Therefore, the eluent has to be removed in order to detect heteroatom containing molecules. Removal of eluent adds extra evaporation step prior to delivering a solute into a combustion oven. Many solvents with high boiling point would be unsuitable for the use in FID for LC.

Transport FIDs were designed to solve the problem of analytes delivery while getting rid of solvents. One of designs involves the use of a moving wire on which the mobile phase is coated. Mobile phase is evaporated, prior to wire entering the detector. Similar idea is used in rotating spokes transport detector, where mobile phase is deposited on the spokes, made out of solid inorganic materials. Spokes pass sequentially first through the evaporator for the mobile phase removal and second through the FID.

To avoid using fragile spokes, a rotating gauze disk was employed in a different transport detector system. Mobile phase was deposited while disk would rotate through evaporation chamber, followed by entering the FID. All described transport detector systems lacked the usual sensitivity, expected for regular FID. This could be explained by residual amounts of mobile phase, delivering a strong noise signal. Another disadvantage was in general fragility, and constant need in cleaning the moving part from burnt residues. Unlike other detectors, FIDs destroy the sample. Thus, other types of detectors must be used in order to avoid all limitations of transport FIDs and for analysis off highly oxygenated molecules, nitrogen-containing molecules and sulfides.

Some systems use the electrical conductivity detector. It measures the conductivity of the total mobile phase. It is sensitive to concentration of all ions present whether they come from solute or from the mobile phase. The disadvantage of this method of detection is in limited use of non-polar and low-ionizable solvents for mobile phase. In such media, traces of dissolved carbon dioxide can provide a significant background noise, making the determination of solute more difficult.

Optical detectors find the widest use in LC. In general, optical LC detectors use a flowthrough cell with one or two windows, which allow measuring absorption, reflection or refraction of the light by a sensor. The small amount of optically active components (analytes) in the liquid mobile phase affects the intensity or angle of the outcoming light. This property is used to determine presence or concentration of analytes in the mobile phase relative to a pure mobile phase.

UV detector commonly involves a Z-type cell, in which a mobile phase passes between two parallel windows. The optical flow enters through one window, passes through a solute and exits through another window moving through a Z-shaped channel. This arrangement allows optical energy to travel inline with the sample flow. The sensitivity of the absorption detector depends on the length of the optical energy path within the sample cell. The longer the optical path, the greater the detector's sensitivity. The major disadvantage of the flow-through Z-type cell, as well as any other flow-through cell geometry, is that the optical length of the cell stays constant. Many analytes go undetected due to their concentration and optical activities falling outside the linear range of the detector. Having a cell with a controllably changing optical length, would allow simultaneous detection of analytes with different concentrations and optical activities in a single run.

Another disadvantage of using glass or quartz cell windows in a previously described flowthrough cell is in their destructibility. Scratches and cracks in the glass usually decrease sensitivity of the detector and increase the noise signal. One way of mitigating this problem was in designing the flow cells with easily accessible windows for replacement and cleaning purposes. However, it leads to extra maintenance and cost.

Z-cell geometry also leads to a problem known as a bubble noise. Often, the analytes have entrained gas or air bubbles. Due to a winding pass through a cell, the bubbles get trapped, causing deviations in the detected absorption spectra due to pulsation in illumination intensity.

Another limitation of the regular UV-detector is collection of only single measurement on the analyte passing through the optical cell. There is no easy way to accumulate signals from the analyte, to increase a signal/noise (S/N) ratio, and/or to detect analytes in low concentration and/or of low optical activity, particularly when the signal response is approaching a noise level of the detector. Also, UV flowthrough detectors are usually limited to measuring of only one type of optical signal, namely absorption, reflection or refraction. There was no detector suggested that could measure all optical properties at once. Moreover, there was no detector that would combine optical and non-optical measurements.

Thus, there is a need in a new and improved LC detector that: (1) provides a cell with controllable changing length of the optical path; (2) eliminates bubble noise; (3) eliminates the use of quarts or glass windows; (4) allows to collect multiple measurements of the same portion of the mobile phase, for signal accumulation; (5) allows to simultaneously measure absorption, refraction and reflection of the sample; (6) allows for simultaneous use of different types of detection.

The disclosed invention addresses these and some other issues related to the current state of the LC technology.

### SUMMARY OF THE INVENTION

Accordingly, the current invention provides a transport detector that allows controlling the length of optical path, while eliminating the use of cell windows and bubble noise. Besides, simultaneous measure of refraction, absorption or reflection is possible in combination with other types of detection.

The proposed detector is comprised of an optically transparent disc made of glass or quartz or any other suitable material which can be rotated with controllable speed around the disc axis. One surface of the disc has a coating of non-wettable material such as polytetrafluoroethylene (PTFE), or the like, leaving a circular non-coated narrow closed line (channel). This channel is placed close to the disc's edge and is wettable with typical mobile phases.

The liquid coming out from an LC column is delivered by a capillary nozzle into the channel. The disc spins around the vertical axis, allowing the mobile phase to fill the channel. The speed of the disc's rotation allows controlling the thickness of the liquid in the channel. Slow rotation forms thicker liquid layer while faster rotation forms thinner liquid layer.

Along the pass of the channel the number of detectors could be installed. For instance, the formed liquid layer is transported via the disc rotation to an optical pair comprising of a light source and a light sensor. This pair is placed in such a way that the optical characteristics of the layer can be measured. These optical characteristics can include, but are not be limited to measuring the light absorption, refraction index, fluorescence emission, etc.

Alternatively or consecutively, other characteristics of the liquid can be measured such as conductivity or electrochemical potential with two electrodes immersed in the layer of liquid.

The liquid can be evaporated if the evaporation chamber is installed along the path of the channel. Physical characteristics of residual material can be measured including but not limited to optical properties, decomposition properties, thickness of residue layer etc.

Multiple sensors could be placed along the rotation path of the mobile phase. The analyte moves with the disc along the channel allowing multiple sensors to measure physical characteristics of the same portion of the mobile phase, producing cumulative signals which can be converted by means of mathematical procedures. Such method of measurement allows a higher S/N representation compared to the commonly used single pass-through measurement. For example, having 100 parallel measurements of the same spatial sample of the mobile phase allows 10 fold increase of the S/N ratio.

To regenerate the wettable surface after all measurement have been made, the cleaning or removing means can be placed along the rotational path which might include a swapping element made of porous material connected to a vacuum pump. This swapping element slides against the disk surface and collects the sample (liquid or solid) by means of vacuum, capillary, and wiping forces.

Additional features of the disclosure will become apparent to those skilled in the art upon consideration of the following detailed description of the illustrative embodiment.

### BRIEF DESCRIPTION OF THE DRAWINGS

The detailed description particularly refers to the accompanying figures in which:

FIG. 1 is a front view of a transport detector with a spinning disk with a wetting channel, embodying the invention.

FIG. 2 is an enlarged view of a cross-section of the wetting channel of a spinning disk with a mobile phase occupying the channel. Four different thicknesses of a mobile phase are shown, representing the ability to control the length of the optical path with the speed of a disk rotation.

FIG. 3 is a cross-section view of the wetting channel with a mobile phase present, showing the light source, focusing optic and a sensor underneath the disk embodying the optical detector.

FIG. 4 is a cross-section view of the wetting channel, showing the electrodes of the conductivity detector inserted into the channel for measuring the electric conductivity of the analyzed liquid.

FIG. 5 is a flow-scheme unfolding the operational sequence of the transport detector described in the specification.

### DETAILED DESCRIPTION OF PREFERRED EMBODIMENTS

For the purposes of promoting and understanding the principles of the invention, reference will now be made to one or more illustrative embodiments illustrated in the drawings and specific language will be used to describe the same.

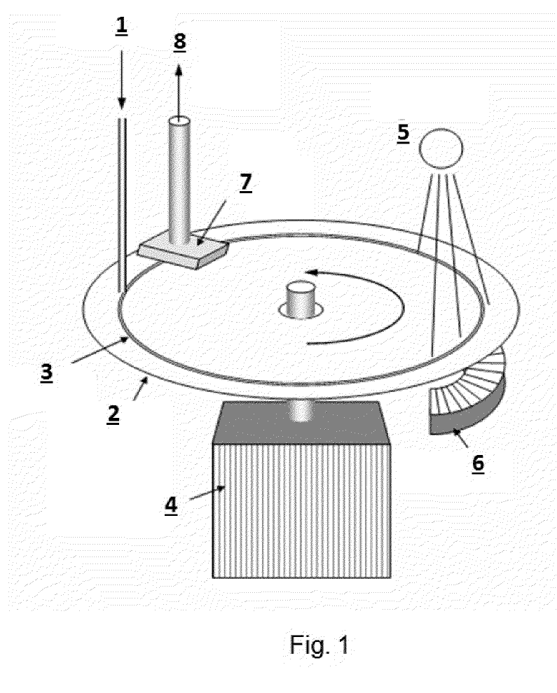

Referring to FIG. 1, a transport detector includes a spinning disk 2 made out of a glass or quartz and covered with a non-wettable material like PTFE. The size of the disk could vary, accommodating different scale chromatography needs. A circular channel 3 on the disk is left without non-wettable material and is transparent to the light. The mobile phase is transported from the column via capillary 1 into the channel. Similar to the size of the disk, the depth and the width of the channel could be manufactured to fit the size of the capillary and the size of the chromatography column.

After entering the channel, the mobile phase is transported via the rotation of the motor 4 spinning the disk. Along the pass of the channel rotation, the light source 5 is mounted. The optical instruments could be used to focus the light precisely into the channel under desired angle. The light will then travel through a mobile phase occupying the channel. Underneath the disk, a number of optical sensors 6 are mounted, measuring the intensity of the light signal as it travels through the mobile phase. The optical properties of the mobile phase change due to the analyte's presence. Sensors detect this change and transform information into a readable media using mathematical equations.

The number of optical sensors is unlimited and their location is not restricted due to the design of current invention. Putting the large number of sensors along the channel path allows performing multiple measures on the same portion of a mobile phase. This advantage improves S/N ratio, providing higher sensitivity of the detector.

As could be seen from the FIG. 1, there is a wiping device 7 at the end of the circular channel path. The purpose of this device is to remove the mobile phase and analytes to regenerate the channel to clean and dry condition for the mobile phase entry. The wiping devise is located right in front of the capillary 1 that delivers the mobile phase. It could be made, but not limited to, from the porous material with high absorption properties. It could also be connected to vacuum 8 to make the solvent removal more efficient. The porous part of the wiping device could be detachable, for easy replacement with the new part after continuous use wear and tear.

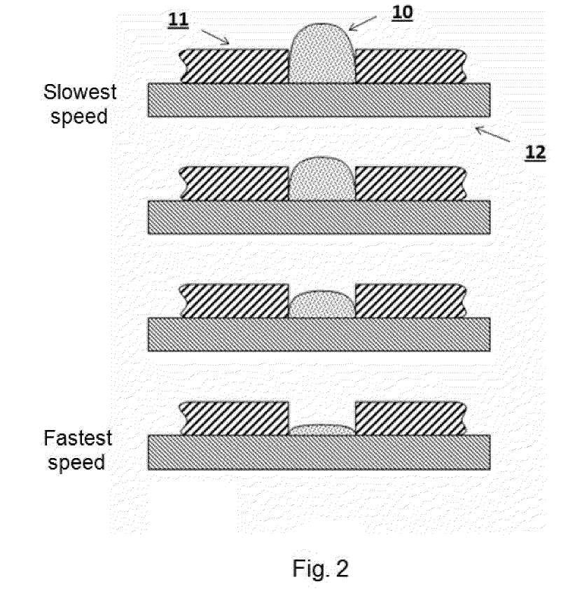

As shown in FIG. 2, the thickness of the mobile phase 10 in the channel could be easily controlled by the speed of the disk rotation. The faster the rotation, the narrower is the thickness of the liquid. This feature of the detector allows managing the optical cell length. Changing the length of the optical path gives the opportunity for detection of analytes with low concentration or low optical activity.

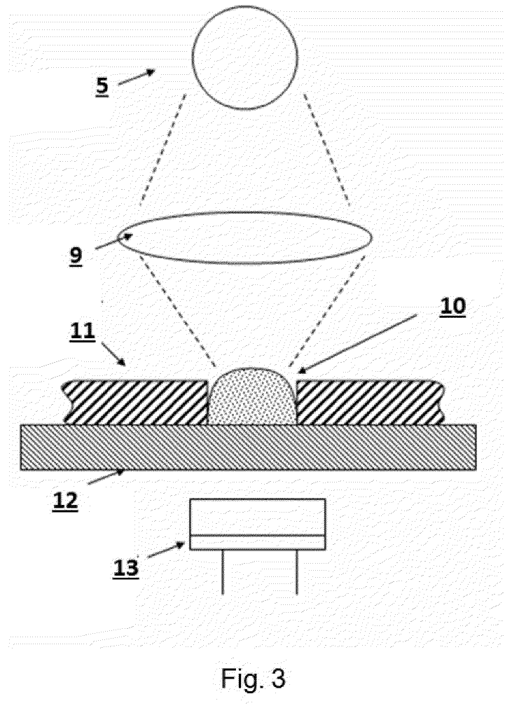

As could be seen from closer view in FIG. 3, the source of the light 5 could be mounted above the channel. The focusing optic 9 could be used to direct the light to enter the mobile phase 10 that travels inside the channel restricted by the walls of the non-transparent material 11 that covers the glass disk. After travelling through the mobile phase, the light will exit on the other side through the transparent glass or quartz surface 12. Sensors 13 could be mounted underneath the channel for the light signal detection. The sensor detects changes in light activity due to the presence of the analyte in the mobile phase.

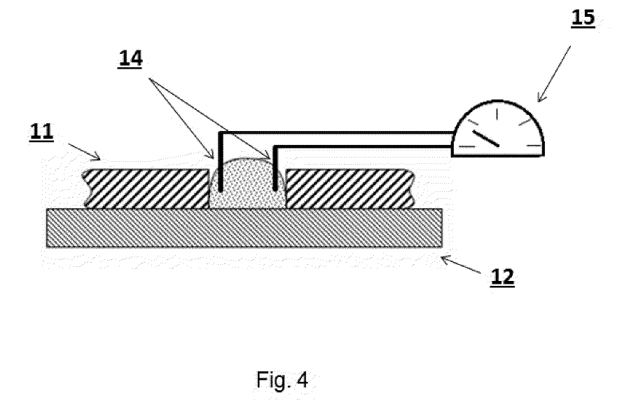

As shown in FIG. 4, electrodes 14 of the conductivity detector 15 could be inserted into the wetting channel to measure the conductivity of the analyzed liquid. The conductivity detector measures changes in the electric conductivity of the mobile phase due to the presence of the analyte in the mobile phase.

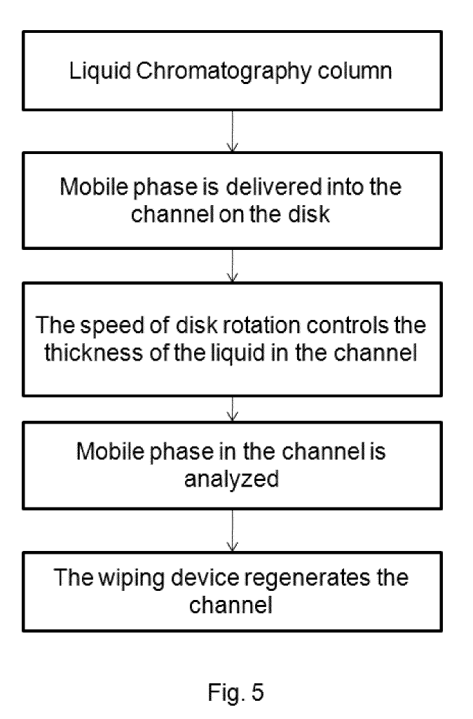

The general operation of the transport detector is summarized in the flow-scheme presented in FIG. 5. After exiting the chromatography column, the mobile phase enters the wetting channel on the disk. The speed of the disk's rotation controls the thickness of the liquid in the channel. The mobile phase is analyzed in the channel and at the end of the rotational path is removed by the wiping device to regenerate the channel for a new portion of the mobile phase.

Figures provide preferred embodiment of the invention. However, the invention is not limited to the disclosed configuration. Optical sensors could be located above the spinning disk to measure reflection of the light from the surface of the disk.

While the invention has been illustrated and described in detail in the foregoing drawings and description, the same is to be considered as illustrative and not restrictive in character, it being understood that only illustrative embodiments thereof have been shown and described and that all changes and modifications that come within the spirit and scope of the invention as defined in the following claims are desired to be protected.

1. A transport detector system comprising:
a disk with a circular channel; and
a motor capable of rotating the disk, the motor operably coupled to the disk;
wherein a mobile phase from a Liquid Chromatography column is delivered into the circular channel of the disk to be analyzed.

2. The transport detector according to claim 1, wherein the disk is made out of a transparent material.

3. The transport detector according to claim 2, wherein the transparent material is selected from a group consisting of glass and quartz.

4. The transport detector according to claim 2, wherein one side of the disk, except the circular channel, is coated with a non-transparent and non-wettable material.

5. The transport detector according to claim 4, wherein the non-transparent and non-wettable material is polytetrafluoroethylene.

6. The transport detector according to claim 1, wherein a source of light is mounted above the circular channel.

7. The transport detector according to claim 6, wherein a focusing optic is used to direct a light from the light source into the circular channel.

8. The transport detector according to claim 1, wherein a plurality of sensors of different kind is placed along the circular channel.

9. The transport detector according to claim 1, wherein an array of sensors of the same kind is placed along the circular channel.

10. The transport detector according to claim 1, wherein conductivity detector electrodes are inserted in the circular channel.

11. The transport detector according to claim 1, wherein the mobile phase is delivered into the circular channel by a capillary attached to a nozzle of the Liquid Chromatography column.

12. The transport detector according to claim 1, wherein at the end of a rotational path of the circular channel a wiping device is located comprising a spongy element attached to a vacuum source.
